(19) United States
(12) Patent Application Publication
(10) Pub. No.: US 2021/0249176 A1
(43) Pub. Date: Aug. 12, 2021

(54) Magnetic composition and magnetic component including the same

(71) Applicant: David Liu, Atlanta, GA (US)

(72) Inventor: David Liu, Atlanta, GA (US)

(21) Appl. No.: 16/783,173

(22) Filed: Feb. 6, 2020

(51) Int. Cl. H01F 27/255; H01F 27/29; H01F 1/12; H01F 27/36; H01F 41/02

(52) U.S. Cl. CPC H01F 27/255; H01F 27/29; H01F 41/0246; H01F 27/365; H01F 1/12

(57) ABSTRACT

A composite magnetic material composition includes: soft magnetic material powders; permanent magnet material powders; and a binder. The material made from this composition magnetic material composition has a relative magnetic permeability of said from 2 to 100. A magnetic core fabricated using this composite magnetic material composition is magnetized, after its fabrication, and a permanent magnetic field is retained in it, regardless of the operation status of the magnetic core. The magnetic flux density of the permanent magnetic field in this magnetic core is in the range of 10 to 2000 gauss. Magnetic components comprising this magnetic core have a higher saturation current.

### TECHNICAL FIELD

This present invention relates to a magnetic composition and magnetic components including the same, and more particularly, to a composite magnetic material composition, and magnetic components having an increased saturation current.

### BACKGROUND

For surface mount magnetic components for electronic devices such as computing devices, entertainment devices, and automotive devices, the challenge has been to provide increasingly miniaturized components so as to minimize the area occupied on a circuit board by the component (sometimes referred to as the component “footprint”). By decreasing the footprint, the size of the circuit board assemblies for electronic devices can be reduced and/or the component density on the circuit board(s) can be increased, which allows for a power density improvement and cost reduction of the electronic device. While the cost reduction in designing and manufacturing components has been of great practical interest to magnetic component manufacturers, the functional features and capabilities of the magnetic components must not be sacrificed. Instead, electronic devices manufacturers demand the electronic components to be not only physically smaller but also offering increased features and improved performance. For some types of components, such as magnetic components that provide energy storage and regulation capabilities, meeting the increased power demands while continuing to reduce the size is very challenging.

Conventional magnetic components typically include a magnetic core and a coil winding wound on the magnetic core. The core may be fabricated from magnetic materials and is typically formed at certain shapes prior winding. The core may include one or more core pieces and the shapes may include I core, EE core, U core, toroidal core, pot core, T core, and other shapes. The core may be bonded with epoxy, or the core may be bonded with epoxy combined with glass beads. The coil winding is fabricated from a conductive wire such as a magnet wire or a tin coated copper wire. The coil winding is fabricated by wrapping the wire around the magnetic core, or the coil winding is completely formed to a certain shape beforehand.

Magnetic cores are typically made from soft magnetic materials. The soft magnetic materials for making the core include but are not limited to soft ferrite magnetic materials, iron-based powder magnetic materials, alloy powder magnetic materials, amorphous magnetic materials, and nanocrystalline magnetic materials. Soft ferrite magnetic materials typically have a high magnetic permeability and a small magnetic saturation flux density, a physical gap is typically needed for the soft ferrite magnetic core to increase the core power handle capability and to make the inductance stable. Due to the low electrical conductivity of the soft ferrite material, the magnetic core loss of the soft ferrite magnetic core is typically low. Metal powder magnetic materials typically have a low magnetic permeability and a high magnetic saturation flux density. Due to the high electrical conductivity of the metal powder, the magnetic core loss of the metal powder magnetic core is typically high.

Since miniaturization of magnetic components has been demanded, magnetic cores need to become physically small and need to have low loss. To meet these requirements, magnetic cores having a high saturation magnetization and a low magnetic loss need to be chosen, however, a low magnetic core loss magnetic material generally has a low saturation magnetization. To reduce the magnetic core physical size, many efforts have been dedicated to increase the magnetic material saturation magnetization while maintaining a low magnetic core loss. Since the saturation magnetization and the magnetic core loss are both mostly determined by the material composition but in substantially opposite way, the saturation magnetization cannot be increased infinitely. Many efforts have been dedicated by magnetic core manufacturers to optimize the magnetic core shapes in order to maximize the usage of the core material. Many efforts have also been contributed by magnetic core manufacturers to simplify the manufacturing processes in order to reduce the manufacturing cost and improve the competitiveness.

It is therefore a primary object, feature, or advantage of the present invention to improve upon the state of the art. It is a further object, feature, or advantage of the present invention to provide a composite magnetic material composition to enhance the saturation magnetization. Another object, feature, or advantage of the present invention is to increase the capability of a magnetic component to effectively handle more DC bias with stable inductance and low core loss. One or more objects, features, or advantages of the present invention will become apparent from the description that follows.

### SUMMARY

An aspect of the present invention may provide a composite magnetic material composition increasing magnetic component saturation current and allowing a magnetic component to be physically small.

An aspect of the present invention may also provide a method of manufacturing a magnetic component for use in an elevated saturation current while having improved electrical performance such as a lower DCR.

An aspect of the present invention may further provide a method of manufacturing a magnetic component having a smaller physical size while having improved electrical performance such as a lower DCR.

According to an aspect of the present invention, a composite magnetic material composition may include: soft magnetic material powder; permanent magnet powder; and binder. The soft magnetic material powder and the permanent magnet powder and the binder are mixed such that the soft magnetic material powder and the permanent magnet powder and the binder are substantially evenly distributed in the mixture. The soft magnetic material powder includes but is not limited to soft ferrite magnetic powders, alloy magnetic powders, iron-based magnetic powders, amorphous magnetic powders, nanocrystalline magnetic powders, or combination thereof. The permanent magnet powder includes but is not limited to hard or permanent ferrite magnet powders, Alnico magnet powders, rare earth magnet powders, or combinations thereof. The ratio of the soft magnetic material powder and the permanent magnet powder in the mixture is in the range of 85:15 to 15:85. The binder includes but is not limited to organic binder and inorganic binder, in liquid state or solid state. The magnetic material made by this composite magnetic material composition has a relative magnetic permeability of said from 2 to 100.

According to another aspect of the present invention, a magnetic core fabricated from the composite magnetic material composition in accordance with an aspect of the present invention described above can be magnetized, typically after fabrication, and a permanent magnetic field is retained in the magnetic core, regardless of the operation status of the magnetic core. The magnetic flux density of the retained permanent magnetic field in the magnetic core is typically in the range of 10 Gauss to 2000 Gauss. The magnetic core can be disposed individually or can be disposed in conjunction with other soft magnetic cores to form a magnetic path. The shape of the magnetic core includes but is not limited to rectangular core, rod core, I core, E core, U core, toroidal core, pot core, T core, and any other shapes that are designed to form a magnetic path or to be a part of a magnetic path, in solid state or in slurry state.

According to another aspect of the present invention, an inductive component may include: a first magnetic core fabricated by a soft magnetic material comprising two side core elements and a center core element disposed between the two side core elements, wherein a cavity is formed between the two side core elements; a coil winding disposed at least partially within the cavity; and a second magnetic core, fabricated from the composite magnetic material composition in accordance with an aspect of the present invention described above, disposed within the cavity of the first magnetic core. End portions of the coil winding are exposed to end surfaces of the first magnetic core opposing each other, a first and a second external terminals provided on the end surfaces of the first magnetic core connected to the end portions of the coil winding, respectively. The second magnetic core is magnetized, before or after the fabrication of the inductive component, a permanent magnetic field is retained in the second magnetic core and the retained permanent magnetic field flux density is in the range of 10 gauss to 2000 gauss. One of the first and second external terminals is designated for an electrical current to flow in the coil winding. When an electrical current flow in the coil winding through the designated external terminal, a magnetic field is generated. The generated magnetic field is substantially contained in the first magnetic core and the second magnetic core and has a substantially opposite polarity with respect to the retained permanent magnetic field in the second magnetic core.

According to another aspect of the present invention, an inductive component may include: a first drum shape magnetic core fabricated from soft magnetic material; a coil winding wound on the first drum shape magnetic core; and a compressed body fabricated from the composite magnetic material composition in accordance with an aspect of the present invention described above. The coil winding and the first drum shape magnetic core are at least partially surrounded by the compressed body. Both end portions of the coil winding are exposed to both end surfaces of the compressed body opposing each other, respectively. First and second external terminals are provided on the end surfaces of the compressed body connected to the end portions of the coil winding, respectively. The compressed body is magnetized after the fabrication of the inductive component, a permanent magnetic field is retained in the compressed body and the retained permanent magnetic field flux density is in the range of 10 gauss to 2000 gauss. One of the first and second external terminals provided on the end surfaces of the compressed body is designated for an electrical current to flow in the coil winding. When an electrical current flow in the coil winding through the designated external terminal, a magnetic field is generated. The generated magnetic field is substantially contained in the first drum shape magnetic core and the compressed body and has a substantially opposite polarity with respect to the retained permanent magnetic field in the compressed body. The shape of the first magnetic core can also be T shape and rod shape.

According to another aspect of the present invention, an inductive component may include: a first magnetic core fabricated from the composite magnetic material composition in accordance with an aspect of the present invention described above; a coil winding wound on the first magnetic core; and a compressed body containing insulated magnetic material having the coil winding and the first magnetic core at least partially embedded therein while both end portions of the coil winding are exposed to both end surfaces of the compressed body opposing each other, respectively. First and second external terminals are provided on the end surfaces of the compressed body connected to the end portions of the coil winding, respectively. The first magnetic core is magnetized, before or after the fabrication of the inductive component, a permanent magnetic field is retained in the first magnetic core and the retained permanent magnetic field flux density is in the range of 10 gauss to 2000 gauss. One of the first and the second external terminals provided on the end surfaces of the compressed body is designated for an electrical current to flow in the coil winding. When an electrical current flow in the coil winding through the designated external terminal, a magnetic field is generated. The generated magnetic field is substantially contained in the first magnetic core and the compressed body and has a substantially opposite polarity with respect to the retained permanent magnetic field in the first magnetic core. The insulated magnetic material for the compressed body includes but is not limited to soft ferrite magnetic powders, iron-based magnetic powders, alloy magnetic powders, amorphous magnetic powders, nanocrystalline magnetic powders, and combination thereof. The shape of the first magnetic core includes but is not limited to T shape and rod shape.

According to another aspect of the present invention, an inductive component may include: a first magnetic core fabricated from soft magnetic material; a coil winding wound on the first magnetic core; and a compressed body fabricated from the composite magnetic material composition in accordance with an aspect of the present invention described above. The coil winding and the first magnetic core are at least partially embedded in the compressed body. Both end portions of the coil winding are exposed to both end surfaces of the compressed body opposing each other, respectively. First and second external terminals are provided on the end surfaces of the compressed body connected to the end portions of the coil winding, respectively. The compressed body is magnetized after the fabrication of the inductive component, a permanent magnetic field is retained in the compressed body and the retained permanent magnetic field flux density is in the range of 10 gauss to 2000 gauss. One of the first and the second external terminals provided on the end surfaces of the compressed body is designated for an electrical current to flow in the coil winding. When an electrical current flow in the coil winding through the designated external terminal, a magnetic field is generated. The generated magnetic field is substantially contained in the first magnetic core and the compressed body and has a substantially opposite polarity with respect to the retained permanent magnetic field in the compressed body. The shape of the first magnetic core includes but is not limited to T shape and rod shape.

According to another aspect of the present invention, a magnetic component may include: a first magnetic core fabricated from soft magnetic material comprising two matched core halves, wherein at least one of the core halves comprising at least two post or two leg elements; a second magnetic core fabricated from the composite magnetic material composition in accordance with an aspect of the present invention described above, wherein the second magnetic core is disposed in the neighborhood of the at least one of the post or leg elements of the at least one of the core halves of the first magnetic core, wherein a winding window is formed by the first magnetic core and the second magnetic core; and at least one coil winding disposed within the winding window. The at least one coil winding has at least one external terminal designated for an electrical current to flow in the coil winding. The first magnetic core geometry typically includes but is not limited to EE core, EC core, EI core, ER core, RM core, PQ core, UU core, UI core, EP core, EPC core, and POT core. The second magnetic core has a substantially same shape as the at least one of the post or leg elements of the at least one of the core halves of the first magnetic core and is magnetized, before or after the fabrication of the magnetic component. A permanent magnetic field is retained in the second magnetic core, and the retained permanent magnetic field flux density is in the range of 10 gauss to 2000 gauss. An electrical current flow in the at least one coil winding through the designated external terminal, and a magnetic field is generated from a flow in electrical current through the at least one coil winding. The generated magnetic field is substantially contained in the first magnetic core and the second magnetic core and has a substantially opposite polarity with respect to the retained permanent magnetic field in the second magnetic core. The at least one coil winding can include a single winding or a plurality of windings. The magnetic component is a flyback transformer, or a transformer with DC bias, or an inductor.

### BRIEF DESCRIPTION OF THE DRAWINGS

The features, objectives, and advantages of the invention will become more apparent from the detailed description set forth below when taken in conjunction with the drawings, wherein:

FIG. 1A is a perspective view of a first exemplary embodiment of the magnetic component configured as a power inductor in accordance with the principles of the present invention.

FIG. 1B illustrates a basic assembly process of the power inductor shown in FIG. 1A.

FIG. 1C illustrates a photograph of the microstructure of the second magnetic core of the power inductor shown in FIG. 1A.

FIG. 1D illustrates DC bias characteristics of a normal power inductor and a power inductor in accordance with the principles of the present invention.

FIG. 2 is a cross section view of a second exemplary embodiment of the magnetic component configured as a drum core power inductor.

FIG. 3 is a cross section view of a third exemplary embodiment of the magnetic component configured as a pressed powder inductor.

FIG. 4 is a cross section view of a fourth exemplary embodiment of the magnetic component configured as a flyback transformer.

### DETAILED DESCRIPTION OF THE INVENTION

Exemplary embodiments of composite magnetic material composition and magnetic components are described below for power management applications having small footprint or low DCR that are difficult, if not impossible, to achieve, using conventional techniques. Exemplary embodiments of composite magnetic material composition and magnetic components may also be fabricated with reduced cost compared to other known magnetic compositions and magnetic components. Manufacturing methodology and steps associated with the magnetic material composition and magnetic components described are in part apparent and in part specifically described below but are believed to be well within the purview of those in the art without further explanation.

The composite magnetic material composition, in accordance with the principles of the present invention, comprising soft magnetic material and permanent magnet material and binder. The soft magnetic material used for the composite magnetic material composition is selected from the group consisting of soft ferrite magnetic material, iron-based magnetic material, alloy magnetic material, amorphous magnetic material, nanocrystalline magnetic material, and combinations thereof. The permanent magnet material used for the composite magnetic material composition is selected from the group consisting of hard or permanent ferrite magnet material, Alnico magnet material, rare earth magnet material, and combinations thereof. The binder used for the composite magnetic material composition includes but is not limited to organic binder and inorganic binder.

An exemplary embodiment of the composite magnetic material composition, in accordance with the principles of the present invention, comprises soft magnetic material powder and permanent magnet powder and binder. The soft magnetic material powder used for the exemplary embodiment of the composite magnetic material composition is selected from the group consisting of soft ferrite magnetic powders, iron-based magnetic powders, alloy magnetic powders, amorphous magnetic powders, nanocrystalline magnetic powders, and combinations thereof. The permanent magnet powder used for the exemplary embodiment of the composite magnetic material composition is selected from the group consisting of hard or permanent ferrite magnet powders, Alnico magnet powders, rare earth magnet powders, and combinations thereof. The binder used for the exemplary embodiment of the composite magnetic material composition includes but is not limited to organic binder and inorganic binder, in liquid state, semi-liquid state, or solid state. The soft magnetic material powder and the permanent magnet powder and the binder are mixed such that the soft magnetic material powder and the permanent magnet powder and the binder are substantially evenly distributed in the mixture. The particle size of the soft magnetic material powder includes but is not limited to 500 μm or smaller. The particle size of the permanent magnet powder includes but is not limited to 500 μm or smaller. The ratio of the soft magnetic material powder and the permanent magnet powder in the mixture includes but is not limited to the range of 85:15 to 15:85. The exemplary embodiment of the composite magnetic material composition has, at least partially, soft magnetic material characteristics including but not limited to, for example, easy magnetization and demagnetization. The exemplary embodiment of the composite magnetic material composition also has, at least partially, permanent magnet material characteristics including but not limited to, for example, creating its own persistent magnetic field once being magnetized.

The magnetic material made from the exemplary embodiment of the composite magnetic material composition has a relative magnetic permeability of said from 2 to 100. The relatively magnetic permeability of this magnetic material can be adjusted by adjusting the ratio of the soft magnetic material powder and permanent magnet powder and binder in the composition.

A magnetic core fabricated by the exemplary embodiment of the composite magnetic material composition is magnetized, typically after fabrication, and a permanent magnetic field is retained in the magnetic core, regardless of the operation status of the magnetic core, the magnetic flux density of the retained permanent magnetic field in the magnetic core is in the range of 10 Gauss to 2000 Gauss. The shape of the magnetic core is selected from the group consisting of rectangular shape, rod shape, I shape, E shape, U shape, toroidal shape, pot shape, T shape, and other shapes that are selected to form a magnetic path or to be a part of a magnetic path, in solid state or in slurry state.

For one example, the magnetic core is fabricated by loading the exemplary embodiment of the composite magnetic material composition into a mold cavity and curing at an elevated temperature wherein an assembly consisting of a drum shape soft magnetic core and a coil winding wound on the drum shape soft magnetic core is loaded beforehand, the assembly consisting of a drum shape soft magnetic core and a coil winding wound on the drum shape soft magnetic core is at least partially surrounded by the magnetic core. The magnetic core is then magnetized so that a permanent magnetic field is retained in it and the permanent magnetic field flux density is in the range of 10 Gauss to 2000 Gauss.

For another example, a rectangular shape magnetic core is fabricated by loading the exemplary embodiment of the composite magnetic material composition into a rectangular shape mold cavity and pressing and curing, the rectangular shape magnetic core is then magnetized so that a permanent magnetic field is retained in it and the permanent magnetic field flux density is in the range of 10 Gauss to 2000 Gauss. The rectangular shape magnetic core can also be magnetized after its assembling with other soft magnetic cores or other coil winding and core assemblies.

The exemplary embodiment of the composite magnetic material composition in accordance with the principles of the present invention, the magnetic material made from the exemplary embodiment of the composite magnetic material composition, and the magnetic core fabricated using the exemplary embodiment of the composite magnetic material composition can be in solid state or in slurry state.

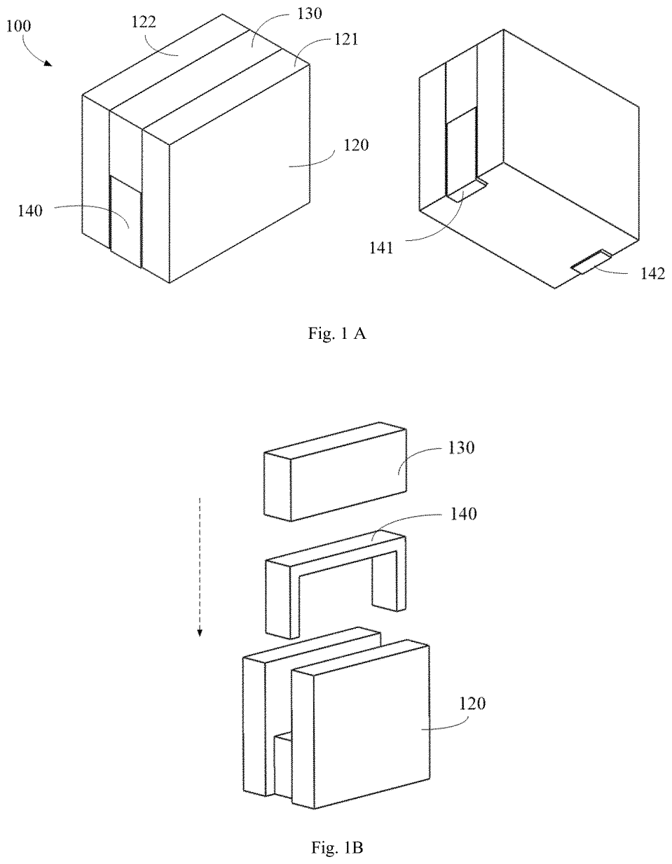

FIG. 1A is a perspective view of a first exemplary embodiment of the magnetic component that is configured as a power inductor 100. As shown in FIG. 1A, the first exemplary embodiment of the magnetic component that is configured as a power inductor 100 generally comprises a first substantially U-shape magnetic core 120, a coil winding 140, and a second substantially rectangular magnetic core 130. The first substantially U-shape magnetic core 120 is defined by two side core elements 121 and 122 and a central core element disposed between these two side core elements, wherein the two side core elements 121 and 122 are substantially taller in height than the central element such that a cavity is formed between these two side core elements. The second substantially rectangular magnetic core 130 is disposed substantially within the cavity of the first substantially U-shape magnetic core 120. The coil winding 140 has a substantially U-shape and is disposed at least partially within the cavity of the first substantially U-shape magnetic core 120 and is substantially under the second substantially rectangular magnetic core 130. End portions of the coil winding 140 are exposed to end surfaces of the first substantially U-shape magnetic core 120 opposing each other, a first surface mount external terminal 141 and a second surface mount external terminal 142 provided near the end surfaces of the first substantially U-shape magnetic core 120 connect to the end portions of the coil winding 140, respectively. The first and the second surface mount external terminal 141 and 142 are designed to connect the power inductor 100 to an electrical circuit. One of the surface mount external terminals, either 141 or 142, is defined for an electrical current to flow in the power inductor 100, and a polarity indicator can be included on the power inductor 100 to indicate the polarity of the power inductor.

The polarity indictor on the power inductor 100 may include, but is not limited to, a dot sign, an arrow sign, a positive sign, a negative sign, a marking, a feature on the first substantially U-shape magnetic core, a feature on the second substantially rectangular magnetic core, a feature on the coil winding, a feature on the external terminals, and a feature that is used to differentiate the end portions of the power inductor.

FIG. 1B illustrates a basic assembly process of the power inductor shown in FIG. 1A. A substantially U-shape coil winding is illustrated in FIG. 1B, however, it is understood that other shape coil windings such as a C-shape coil winding and a Pulse-shape coil winding, although a bending process may be involved, have a fundamentally same function, and it is in part apparent and believed to be well within the purview of those in the art without further explanation.

The first substantially U-shape magnetic core 120 is made from soft magnetic material includes, but is not limited to, soft ferrite magnetic materials, iron-based magnetic materials, alloy magnetic materials, amorphous magnetic materials, nanocrystalline magnetic materials, composite magnetic materials, and combinations thereof.

The second substantially rectangular magnetic core 130 is made from the exemplary embodiment of the composite magnetic material composition described above. The second substantially rectangular magnetic core is magnetized, after its fabrication or after the fabrication of the power inductor 100, and a permanent magnetic field is retained in it, regardless of the operation status of the power inductor 100. The magnetic flux density of the retained permanent magnetic field in the second substantially rectangular magnetic core is typically in the range of 10 Gauss to 2000 Gauss.

The retained permanent magnetic field distributes in the second substantially rectangular magnetic core 130 substantially uniformly and has a polarity such that the north pole is substantially point to one of the two side core elements of the first substantially U-shape core 120.

During operation, an electrical current flow in the coil winding 140 through the defined surface mount external terminal, and a magnetic field is generated. The generated magnetic field is substantially contained in the first substantially U-shaped magnetic core 120 and the second substantially rectangular magnetic core 130 and has a substantially opposite polarity with respect to the retained permanent magnetic field in the second substantially rectangular magnetic core 130.

FIG. 1C illustrates a photograph of the microstructure of the second substantially rectangular magnetic core 130 of the power inductor 100 shown in FIG. 1A and FIG. 1B. Referring to FIG. 1C, a mixture obtained by mixing soft magnetic material powders having particle size of 500 μm or smaller and permanent magnet powders comprising hard or permanent ferrite magnet powders having particle size of 500 μm or smaller at a mixing ratio of 70:30, a binder is added to the mixture to hold the powders together. By adjusting the mixing ratio, different material characteristics including but not limited to different magnetic permeabilities and saturation magnetizations can be obtained. Typical ratio to get a good magnetic permeability and a good saturation magnetization includes, but is not limited to, from 85:15 to 15:85. By changing the soft magnetic material powder type and permanent magnet powder type, different material characteristics including but not limited to different frequency response, temperature characteristics, and core loss characteristics can also be obtained. For one example, if the soft magnetic material powder is soft manganese-zinc (MnZn) ferrite powder, the core loss characteristic is typically good, but the saturation magnetization characteristic is not favorable. For another example, if the permanent magnet powder is neodymium magnet powder, the saturation characteristic is typically very good, but the core loss characteristic and temperature characteristic at an elevated temperature are not favorable.

FIG. 1D illustrates DC bias characteristics of a normal power inductor and a power inductor 100 in accordance with the first exemplary embodiment of the magnetic component. A normal soft ferrite-based power inductor and the power inductor 100 in accordance with the first exemplary embodiment of the magnetic component have been constructed and tested. The soft ferrite magnetic material used for the soft ferrite-based power inductor is exactly the same as that used for the first substantially U-shape magnetic core 120 of the power inductor 100, the physical dimensions, open circuit inductance, and DC resistance of these two power inductors are substantially the same. As illustrated in FIG. 1D, curve 1 is the DC bias current characteristic of the normal soft ferrite-based power inductor, and curve 2 is the DC bias current characteristic of the power inductor 100 in accordance with the first exemplary embodiment of the magnetic component. Power inductor's saturation current is defined as the applied DC current at which the inductance value drops a specified amount below its measured value with no DC current. As illustrated in FIG. 1D, for a 20% inductance drop, the power inductor 100 has a DC saturation current of about 85A while the normal soft ferrite-based power inductor has a DC saturation current of about 60A. A 42% improvement of the DC saturation current has obtained. Alternatively, if the DC saturation current is maintained the same and modify the dimensions of the cores and coil winding, a smaller footprint and a lower DC resistance can be obtained for the power inductor 100, either separately or simultaneously.

Other types and other geometries and configurations of electromagnetic components may benefit from the teachings described above, including inductive components other than power inductors, and including transformer components.

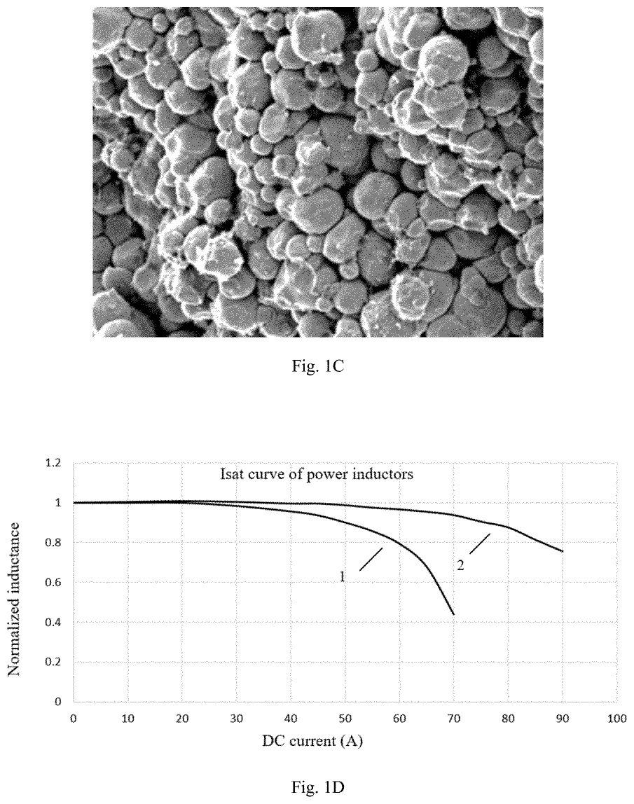

FIG. 2 is a cross section view of a second exemplary embodiment of the magnetic component configured as a drum core power inductor 200 in accordance with the principles of the present invention. As shown in FIG. 2, the second exemplary embodiment of the magnetic component that is configured as a drum core power inductor 200 generally includes a first drum shape magnetic core 220, a coil winding 240 wound on the first drum shape magnetic core 220, and an outside magnetic shield core 230. The first drum shape magnetic core 220 and the coil winding 240 are substantially surrounded by the outside magnetic shield core 230. There is no magnetic gap between the outside magnetic shield core 230 and the first drum shape magnetic core 220. End portions of the coil winding 240 are exposed to end surfaces of the outside magnetic shield core 230 opposing each other, a first surface mount external terminal 241 and a second surface mount external terminal 242 provided on the end surfaces of the outside magnetic shield core 230 connect to the end portions of the coil winding 240, respectively. The first surface mount external terminal 241 and the second surface mount external terminal 242 are designed to connect the drum core power inductor 200 to an electrical circuit. One of the surface mount external terminals, either 241 or 242, is designated for an electrical current to flow in the coil winding 240, and a polarity indicator can be included on the drum core power inductor 200 to indicate the polarity of the power inductor.

A polarity indictor can be included on the drum core power inductor 200 in accordance with the second exemplary embodiment of the magnetic component. The polarity indictor on the power inductor 200 includes, but is not limited to, a dot sign, an arrow sign, a positive sign, a negative sign, a marking, a feature on the first drum shape magnetic core, a feature on the outside magnetic shield core, a feature on the external terminals, and a feature that is used to differentiate the end portions of the drum core power inductor.

The first drum shape magnetic core 220 is made from soft magnetic material includes, but is not limited to, soft ferrite magnetic materials, iron-based magnetic materials, alloy magnetic materials, amorphous magnetic materials, nanocrystalline magnetic materials, composite magnetic materials, and combinations thereof.

The outside magnetic shield core 230 is fabricated from the exemplary embodiment of the composite magnetic material composition, and it is magnetized typically after the fabrication of the drum core power inductor 200. A permanent magnetic field 251 with a magnetic flux Φr is retained in the outside magnetic shield core 230, regardless of the operation status of the drum core power inductor 200. The magnetic flux density of the retained permanent magnetic field in the outside magnetic shield core 230 is typically in the range of 10 Gauss to 2000 Gauss. During the operation, an electrical current flow in the coil winding 240 through the designated surface mount external terminal and a magnetic field 252 with a magnetic flux Φc is generated in the first drum shape magnetic core 220. At least a portion of this magnetic flux Φc circulates to the outside magnetic shield core 230. The at least a portion of the magnetic flux Φc circulating to the outside magnetic shield core 230 has a substantially opposite polarity with respect to the magnetic flux Φr of the retained permanent magnetic field 251.

The coil winding 240 is a conductive winding comprising a single turn or a plurality of turns.

The coil winding 240 contains single winding or a plurality of windings. The drum core power inductor 200 can be a single-phase power inductor or a multi-phase power inductor or a couple power inductor.

The second exemplary embodiment of the magnetic component that is configured as a drum core power inductor 200 can also comprise a first drum shape magnetic core fabricated from the exemplary embodiment of the composite magnetic material composition described above, a coil winding wound on the first drum shape magnetic core, and an outside magnetic shield core fabricated by soft magnetic material including but not limited to soft ferrite magnetic materials, iron-based magnetic materials, alloy magnetic materials, amorphous magnetic materials, nanocrystalline magnetic materials, composite magnetic materials, and combinations thereof. The first drum shape magnetic core, together with the coil winding, is at least partially surrounded by the outside magnetic shield core. The first drum shape magnetic core fabricated from the exemplary embodiment of the composite magnetic material composition is magnetized and a permanent magnetic field is retained in it. The coil winding has at least a first conductive external terminal and a second conductive external terminal to connect the drum core power inductor to an electrical circuit, and one of the first and the second external terminals is designated for an electrical current to flow in the coil winding, such that generated magnetic field resultant from a flow in electrical current through the coil winding is substantially contained in the first drum shape magnetic core and the outside magnetic shield core and has a substantially opposite polarity with respect to the retained permanent magnetic field in the first drum shape magnetic core.

Other similar types and other similar geometries and configurations of drum core magnetic components may benefit from the teachings described above including but not limited to dual inductor components, common mode inductive components, and transformer components.

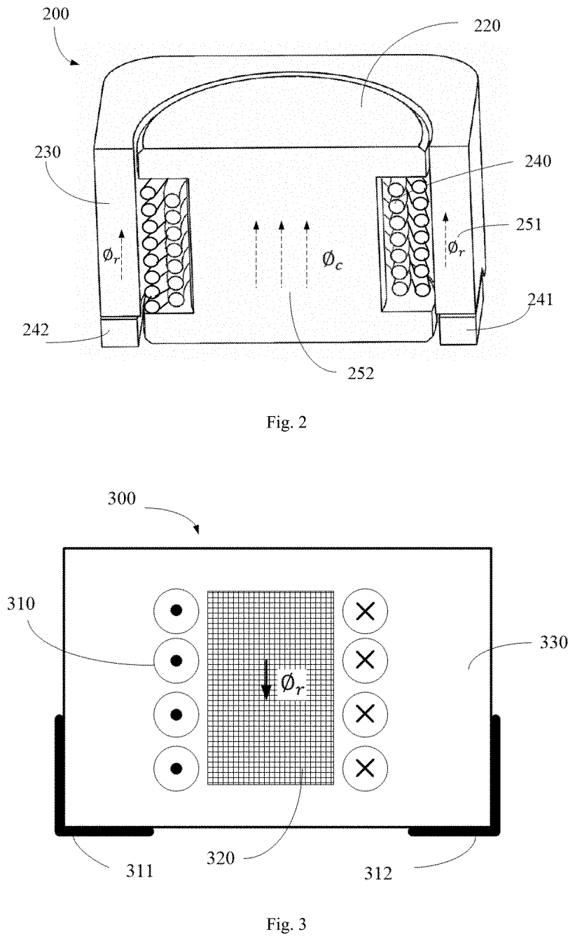

FIG. 3 is a cross section view of a third exemplary embodiment of the magnetic component configured as a pressed powder inductor 300 in accordance with the principles of the present invention. As shown in FIG. 3, the third exemplary embodiment of the magnetic component that is configured as a pressed powder inductor 300 generally comprises a first rod shape magnetic core 320, a coil winding 310 substantially wound on the first rod shape magnetic core 320, and a compressed body 330 having the coil winding 310 and the first rod shape magnetic core 320 completely embedded therein while both end portions of the coil winding are exposed to both end surfaces of the compressed body 330 opposing each other, respectively. A first external terminal 311 and a second external terminal 312 are provided on the end surfaces of the compressed body 330 connected to the end portions of the coil winding 310, respectively.

The first rod shape magnetic core 320 is made from the exemplary embodiment of the composite magnetic material composition described above. The first rod shape magnetic core 320 is magnetized typically after the fabrication of the pressed powder inductor 300, a permanent magnetic field is retained in the first rod shape magnetic core 320 and the retained permanent magnetic field flux density is in the range of 10 gauss to 2000 gauss.

The compressed body 330 comprises soft magnetic material powders including but not limited to soft ferrite magnetic powders, iron-based magnetic powders, alloy magnetic powders, amorphous magnetic powders, nanocrystalline magnetic powders, composite magnetic powders, and combinations thereof. For example, the compressed body 330 is fabricated from a mixture comprising alloy magnetic material powders and a binder.

One of the first external terminal 311 and the second external terminal 312 provided on the end surfaces of the compressed body 330 and connected to the end portions of the coil winding 310 is designated for an electrical current to flow in the coil winding 310, magnetic field generated from a flow in electrical current through the coil winding 310 is substantially contained in the first rod shape magnetic core 320 and the compressed body 330 and has a substantially opposite polarity with respect to the retained permanent magnetic field in the first rod shape magnetic core 320.

The shape of the first magnetic core includes but is not limited to rod shape and T shape.

The coil winding 310 is a conductive winding comprising a single turn or a plurality of turns.

The coil winding 310 contains single winding or a plurality of windings. The pressed powder inductor 300 in accordance with the third exemplary embodiment of the magnetic component can be a single-phase power inductor or a multi-phase power inductor or a couple power inductor.

A polarity indictor can be included on the pressed powder inductor 300 to indicate the polarity. The polarity indictor on the pressed powder inductor 300 includes, but is not limited to, a dot sign, an arrow sign, a positive sign, a negative sign, a marking, a feature on the compressed body, a feature on the external terminals, and a feature that is used to differentiate the end portions of the pressed powder inductor.

The third exemplary embodiment of the magnetic component that is configured as a pressed powder inductor can also include other combinations. For one example, the third exemplary embodiment of the magnetic component that is configured as a pressed powder inductor comprises a first rod shape magnetic core formed by soft magnetic material with no permanent magnetic field retained, a coil winding wound on the first rod shape magnetic core, and a compressed body formed by the exemplary embodiment of the composite magnetic material composition described above. The compressed body has the coil winding and the first rod shape magnetic core completely embedded therein while both end portions of the coil winding are exposed to both end surfaces of the compressed body opposing each other, respectively. A first external terminal and a second external terminal are provided on the end surfaces of the compressed body connected to the end portions of the coil winding, respectively. The compressed body is magnetized after the fabrication of the pressed powder inductor, a permanent magnetic field is retained in it and the retained permanent magnetic field flux density is in the range of 10 gauss to 2000 gauss. One of the first external terminal and the second external terminal provided on the end surfaces of the compressed body is designated for an electrical current to flow in the coil winding, magnetic field generated from a flow in electrical current through the coil winding is substantially contained in the first rod shape magnetic core and the compressed body and has a substantially opposite polarity with respect to the retained permanent magnetic field in the compressed body.

For another example, the third exemplary embodiment of the magnetic component that is configured as a pressed powder inductor comprises a first rod shape magnetic core formed by the exemplary embodiment of the composite magnetic material composition described above, a coil winding wound on the first rod shape magnetic core, and a compressed body formed by the exemplary embodiment of the composite magnetic material composition described above. The compressed body has the coil winding and the first rod shape magnetic core completely embedded therein while both end portions of the coil winding are exposed to both end surfaces of the compressed body opposing each other, respectively. A first external terminal and a second external terminal provided on the end surfaces of the compressed body connect to the end portions of the coil winding, respectively. The first rod shape magnetic core is magnetized after its fabrication, a permanent magnetic field is retained in it and the retained permanent magnetic field flux density is in the range of 10 gauss to 2000 gauss. The compressed body is magnetized after the fabrication of the pressed powder inductor, a permanent magnetic field is retained in it and the retained permanent magnetic field flux density is in the range of 10 gauss to 2000 gauss. One of the first external terminal and the second external terminal provided on the end surfaces of the compressed body is designated for an electrical current to flow in the coil winding. When an electrical current flow in the coil winding through the designated external terminal, a magnetic field is generated. The generated magnetic field is substantially contained in the first rod shape magnetic core and the compressed body and has a substantially opposite polarity with respect to the retained permanent magnetic field in both the compressed body and the first rod shape magnetic core.

Other similar types and other similar geometries and configurations of pressed powder magnetic components may benefit from the teachings described above including but not limited to dual inductor components, common mode inductive components, and transformer components.

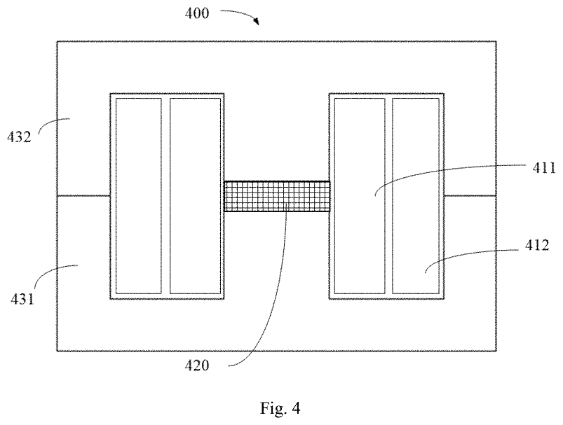

FIG. 4 is a cross section view of a fourth exemplary embodiment of the magnetic component that is configured as a flyback transformer 400 in accordance with the principles of present invention. As shown in FIG. 4, the fourth exemplary embodiment of the magnetic component that is configured as a flyback transformer 400 generally includes a first magnetic core comprising two matched core halves 431 and 432 having an E shape, a second magnetic core 420 having a substantially same shape as the center post of the first magnetic core disposed between the center posts of the two matched core halves of the first magnetic core, a primary winding 411 disposed at least partially within the core winding window, and a secondary winding 412 disposed at least partially within the core winding window.

The second magnetic core 420 is fabricated from the exemplary embodiment of the composite magnetic material composition described above. The second magnetic core is magnetized after its fabrication or after the fabrication of the flyback transformer 400, and a permanent magnetic field is retained in it. The retained permanent magnetic field flux density is in the range of 10 gauss to 2000 gauss.

The first magnetic core comprising two matched core halves 431 and 432 is made from soft magnetic material including but not limited to soft ferrite magnetic materials, iron-based magnetic materials, alloy magnetic materials, amorphous magnetic materials, nanocrystalline magnetic materials, composite magnetic materials, and combinations thereof.

The primary winding 411 is electrically connected to an electrical circuit such that an electrical current flow in the primary winding 411 and a magnetic field is generated from the flow in electrical current through the primary winding 411. The generated magnetic field is substantially contained in the first magnetic core and the second magnetic core 420 and has a substantially opposite polarity with respect to the retained permanent magnetic field in the second magnetic core 420.

The first magnetic core comprising two matched core halves 431 and 432 can be configured to other shape cores including but not limited to EC core, EI core, EE core, PQ core, RM core, EPC core, EFD core, and pot core.

The second magnetic core 420 fabricated from the exemplary embodiment of the composite magnetic material composition can also be disposed between the side posts of the first magnetic core halves, on either side or on both sides, or disposed between all the posts in an alterative way.

The fourth exemplary embodiment of the magnetic component that is configured as a flyback transformer 400 can also have the secondary winding 412 electrically connected to an electrical circuit such that an electrical current flow in the secondary winding 412 and a magnetic field is generated from the flow in electrical current through the secondary winding 412. The generated magnetic field is substantially contained in the first magnetic core and the second magnetic core and has a substantially opposite polarity with respect to the retained permanent magnetic field in the second magnetic core 420.

Other similar types and other similar geometries and configurations of electromagnetic components may benefit from the teachings described above, including transformers with bias current on either or both primary winding and secondary winding, and including power inductors having single winding or a plurality of windings.

This written description uses examples to disclose the invention, including the best mode, and also to enable any person skilled in the art to practice the invention, including making and using any components or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A composite magnetic material composition comprising:
soft magnetic material powder;
permanent magnet powder; and
binder;
wherein the soft magnetic material powder and the permanent magnet powder and the binder are mixed such that the soft magnetic material powder and the permanent magnet powder and the binder are substantially evenly distributed in the mixture; and
wherein the ratio of the soft magnetic material powder and the permanent magnet powder in the mixture is in the range of 85:15 to 15:85.

2. The composite magnetic material composition of claim 1, wherein the soft magnetic material powder is selected from the group consisting of soft ferrite magnetic powder, iron-based magnetic powder, alloy magnetic powder, amorphous magnetic powder, nanocrystalline magnetic powder, and combinations thereof.

3. The composite magnetic material composition of claim 2, wherein the particle size of the soft magnetic material powder is substantially within 500 μm.

4. The composite magnetic material composition of claim 1, wherein the permanent magnet powder is selected from the group consisting of hard or permanent ferrite magnet powder, Alnico magnet powder, rare earth magnet powder, and combinations thereof.

5. The composite magnetic material composition of claim 4, wherein the particle size of the permanent magnet powder is substantially within 500 μm.

6. A magnetic material fabricated from the composite magnetic material composition of claim 1 has a relative magnetic permeability of 2 to 100.

7. A magnetic core fabricated from the composite magnetic material composition of claim 1 is magnetized, after its fabrication, and a permanent magnetic field is retained in it, regardless of the operation status of the magnetic core, wherein the magnetic flux density of the retained permanent magnetic field in the magnetic core is in the range of 10 Gauss to 2000 Gauss.

8. The magnetic core of claim 7, wherein the shape of the core is selected from the group consisting of rectangular shape, rod shape, I shape, E shape, U shape, toroidal shape, pot shape, T shape, and other shapes that are selected to form a magnetic path or to match and couple with other soft magnetic cores.

9. An inductive component comprising:
a first magnetic core fabricated from a soft magnetic material comprising two side core elements and a center core element disposed between the two side core elements;
wherein relative sizes of the center core element and the two side core elements are selected so that a cavity is formed between the two side core elements;
wherein the width of the cavity is equal to or greater than 500 μm;
a coil winding disposed at least partially within the cavity;
wherein end portions of the coil winding are exposed to end surfaces of the first magnetic core opposing each other, a first and a second external terminals provided near or on the end surfaces of the first magnetic core connect to the end portions of the coil winding, respectively; and
a second magnetic core that is fabricated from the composite magnetic material composition of claim 1 disposed substantially within the cavity of the first magnetic core.

10. The inductive components of claim 9, wherein the soft magnetic material comprises soft ferrite magnetic materials.

11. The inductive components of claim 9, wherein the second magnetic core is magnetized, after its fabrication, and a permanent magnetic field is retained in it, the retained permanent magnetic field flux density is in the range of 10 gauss to 2000 gauss.

12. The inductive component of claim 11, wherein one of the first and second external terminals connected to the coil winding is designated for an electrical current to flow in the coil winding such that generated magnetic field resultant from a flow in electrical current through the coil winding is substantially contained in the first and second magnetic core and has a substantially opposite polarity with respect to the retained permanent magnetic field in the second magnetic core.

13. An inductive component comprising:
a first magnetic core fabricated from a soft magnetic material;
a coil winding substantially wound on the first magnetic core;
conductive terminals for connecting the coil winding to an electrical circuit; and
a body containing the composite magnetic material composition of claim 1 that tightly surround and shield the coil winding and at least partially surround and shield the first magnetic core.

14. The inductive component of claim 13, wherein the body is magnetized, after the fabrication of the inductive component, and a permanent magnetic field is retained in it, the retained permanent magnetic field flux density is in the range of 10 gauss to 2000 gauss.

15. The inductive component of claim 14, wherein one of the conductive terminals is designated for an electrical current to flow in the coil winding such that generated magnetic field resultant from a flow in electrical current through the coil winding is substantially contained in the first magnetic core and the body and has a substantially opposite polarity with respect to the retained permanent magnetic field in the body.

16. The inductive component of claim 13, wherein the coil winding includes a single winding or a plurality of windings.

17. The inductive component of claim 13, wherein the shape of the first magnetic core is selected from the group consisting of rectangular shape, rod shape, I shape, drum shape, and T shape.

18. An inductive component comprising:
a first magnetic core fabricated from the composite magnetic material composition of claim 1;
a coil winding substantially wound on the first magnetic core;
conductive terminals for connecting the coil winding to an electrical circuit; and
a compressed body comprising of insulated magnetic material having the first magnetic core and the coil winding completely embedded therein.

19. The inductive component of claim 18, wherein the first magnetic core is magnetized, after the fabrication of the inductive component, and a permanent magnetic field is retained in it, the retained permanent magnetic field flux density is in the range of 10 gauss to 2000 gauss.

20. The inductive component of claim 19, wherein one of the conductive terminals is designated for an electrical current to flow in the coil winding such that generated magnetic field resultant from a flow in electrical current through the coil winding is substantially contained in the first magnetic core and the compressed body and has a substantially opposite polarity with respect to the retained permanent magnetic field in the first magnetic core.

21. The inductive component of claim 18, wherein the coil winding includes a single winding or a plurality of windings.

22. The inductive component of claim 18, wherein the insulated magnetic material comprises powders that are selected from the group consisting of soft ferrite magnetic powders, iron-based magnetic powders, alloy magnetic powders, amorphous magnetic powders, nanocrystalline magnetic powders, and combinations thereof.

23. The inductive component of claim 18, wherein the shape of the first magnetic core is selected from the group consisting of rectangular shape, rod shape, I shape, drum shape, and T shape.

24. An electromagnetic component comprising:
a first magnetic core fabricated from soft magnetic material comprising two matched core halves, at least one of the two core halves comprising at least two post or two leg core elements;
a second magnetic core fabricated from the composite magnetic material composition of claim 1;
wherein the second magnetic core is disposed in the neighborhood of at least one of the at least two post or leg core elements of the at least one of the two core halves of the first magnetic core;
wherein at least one winding window is formed by the first magnetic core and the second magnetic core; and
at least one coil winding disposed at least partially within the at least one winding window.

25. The electromagnetic component of claim 24, wherein the geometry of the first magnetic core is selected from the group consisting of EE core, EC core, EI core, ER core, RM core, PQ core, UU core, UI core, EP core, EPC core, POT core, and combinations thereof.

26. The electromagnetic component of claim 24, wherein the second magnetic core is magnetized, after its fabrication or after the fabrication of the electromagnetic component, and a permanent magnetic field is retained in it, regardless of the operation status of the electromagnetic component, the retained permanent magnetic field flux density is in the range of 10 gauss to 2000 gauss.

27. The electromagnetic component of claim 26, wherein the at least one coil winding has at least two external terminals connected to the end portions of the at least one coil winding, and one of the at least two external terminals is designated for an electrical current to flow in the at least one coil winding such that generated magnetic field resultant from a flow in electrical current through the at least one coil winding is substantially contained in the first magnetic core and the second magnetic core and has a substantially opposite polarity with respect to the retained permanent magnetic field in the second magnetic core.

28. The electromagnetic component of claim 24, wherein the electromagnetic component is a flyback transformer.

29. The electromagnetic component of claim 24, wherein the electromagnetic component is an inductor.
